(19) United States
(12) Patent Application Publication
(10) Pub. No.: US 2019/0235356 A1
(43) Pub. Date: Aug. 1, 2019

(54) DEVICE FOR OPERATING A TOUCHSCREEN AND TAKING SELF-PORTRAITS

(71) Applicant: Opkix, Inc., Costa Mesa, CA (US)

(72) Inventors: Ryan Mikah Fuller, Costa Mesa, CA (US); Tamio Lucien Stehrenberger, Laguna Niguel, CA (US); Shahin Amirpour, Huntington Beach, CA (US); John McGuinness, Huntington Beach, CA (US); Christopher Lawrence Greaves, Huntington Beach, CA (US); Christopher Steven David Albanese, Huntington Beach, CA (US)

(21) Appl. No.: 16/265,213

(22) Filed: Feb. 1, 2019

Related U.S. Application Data
(60) Provisional application No. 62/625,237, filed on Feb. 1, 2018.

(51) Int. Cl. G03B 17/56; G06F 3/0354; F16M 13/04; F16M 13/06

(52) U.S. Cl. CPC G03B 17/561; G06F 3/03545; F16M 13/06; G03B 17/563; F16M 13/04; G03B 17/568

(57) ABSTRACT

A device for operating a touchscreen and taking self-portraits with a camera. The device can include a shaft, a stylus pen tip, and a camera mount. The stylus pen tip can be provided at a first end of the shaft and can be configured to operate a touchscreen device, such as a smartphone. The camera mount can be provided at a second end of the shaft and can be configured to securely attach a camera to the shaft.

### INCORPORATION BY REFERENCE TO ANY PRIORITY APPLICATIONS

This application claims priority to U.S. Provisional Patent Application No. 62/625,237, filed Feb. 1, 2018, and entitled “DEVICE FOR OPERATING A TOUCHSCREEN AND TAKING SELF-PORTRAITS.” Any and all applications for which a foreign or domestic priority claim is identified above and/or in the Application Data Sheet as filed with the present application are hereby incorporated by reference under 37 CFR 1.57.

### BACKGROUND

### Field

The field of the invention relates to accessories for personal computing devices, such as smartphones.

### Description of the Related Art

Personal computing devices, such as smartphones, notebook computers, and tablets, are ubiquitous. These devices often have touchscreens which can be operated by a user's finger, but some users prefer to use a stylus pen instead. If a user is already going to carry a stylus pen to operate his or her touchscreen device, it would be advantageous if the stylus pen could perform an additional function as well.

### SUMMARY

In some embodiments, a device comprises: a shaft; a stylus pen tip at a first end of the shaft, the stylus pen tip being configured to operate a touchscreen device; a camera mount at a second end of the shaft, the camera mount being configured to securely attach a camera to the shaft.

### BRIEF DESCRIPTION OF THE DRAWINGS

Details of one or more embodiments of the subject matter described in this specification are set forth in the accompanying drawings and the description below. Other features, aspects, and advantages will become apparent from the description, the drawings, and the claims.

FIG. 1 illustrates an example embodiment of a telescoping stylus pen with an integrated camera mount.

FIG. 2 illustrates the stylus pen of FIG. 1 in a non-extended configuration while in use for providing input to a personal computing device.

FIG. 3A illustrates an example embodiment of the handle section of the stylus pen.

FIG. 3B illustrates an example embodiment of the camera mount for the stylus pen.

FIG. 3C illustrates another example embodiment of a camera mount for the stylus pen.

FIG. 4 illustrates an example embodiment of a camera which can be attached to the integrated camera mount of the stylus pen shown in FIG. 1.

### DETAILED DESCRIPTION

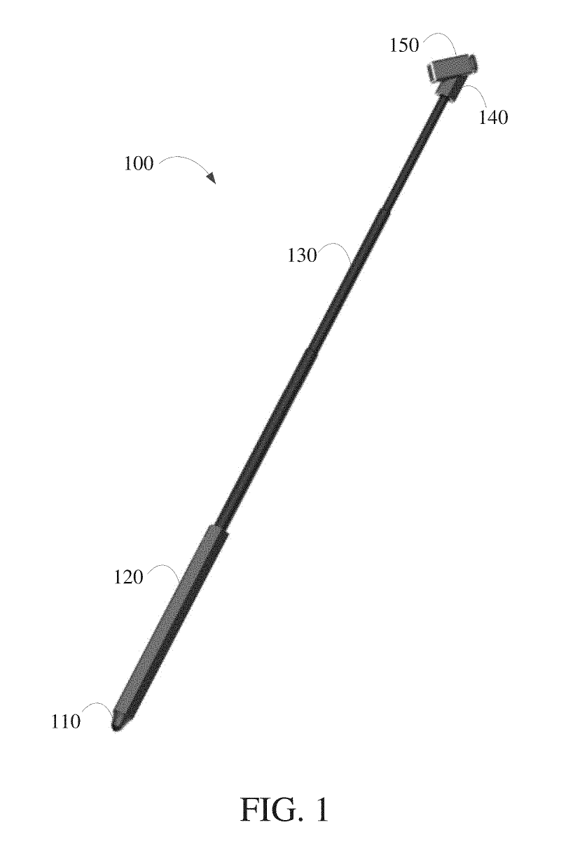

FIG. 1 illustrates an example embodiment of a telescoping stylus pen 100 with an integrated camera mount 140. The stylus pen 100 includes a stylus pen tip 110 at one end. The stylus pen tip 110 can be tapered but with a shape that is blunt enough to contact a touchscreen without damaging the touchscreen. In some embodiments, the stylus pen tip 110 can be made from a resilient material, such as rubber. The stylus pen tip may be designed to be capable of operating with a variety of touchscreen technologies, such as resistive touchscreens, capacitive touchscreens (which may necessitate a conductive stylus pen tip 110), optical imaging touchscreens, electromagnetic resonance touchscreens, etc. In some embodiments, the stylus pen 100 may be Bluetooth®-enabled.

Besides simply allowing a user to provide input to a touchscreen display, the stylus pen 100 can include a camera mount 140 at its opposite end from the stylus pen tip 110. The integrated camera mount 140 can have a synergistic effect by allowing the stylus pen 100 to also serve as a handle for a mounted camera 150 which the user may already carry on a regular basis. In some embodiments, the camera mount 140 can be designed to work with a standalone portable camera or with the very smartphone whose touchscreen the stylus pen is designed to operate.

The camera mount 140 can be, for example, a screw mount, a magnetic mount, a mechanical jaw mount (e.g., spring-loaded), a clip mount, a slide-in mount with friction lock, etc. The camera mount 140 can be designed to work with a wide variety of cameras and smartphones. The camera mount 140 may include a mating surface which is provided at an angle with respect to the shaft of the stylus pen 100. The angle of the mating surface may be, for example, 20°-70° with respect to the longitudinal axis of the stylus pen 100. The angle of the mating surface can be selected so as to provide a natural view of the user's face while he or she is holding the stylus pen 100 in the extended configuration. In other embodiments, the camera mount 140 may have an adjustable camera mounting angle to allow the camera 150 to be mounted in any desired orientation.

In addition, the stylus pen 100 can have a telescoping shaft 130 which can allow the camera 150 to be held at a greater distance away from the user, thereby increasing the utility of the telescoping stylus pen 100 for taking self-portraits (commonly referred to as “selfies”). FIG. 1 shows the telescoping stylus pen 100 in the extended configuration. As illustrated, the telescoping shaft can be made up of several sections which are slidably engaged with one another (e.g., with a friction fit). One of the sections of the telescoping stylus pen 100 can be a handle section 120. The handle section 120 can have features (e.g., contours, ridges, etc.) for improving the ability of the user to grip the stylus pen 100. In some embodiments, the handle section 120 can be at least partially hollow so as to receive the other sections of the telescoping shaft 130 when the stylus pen is in the non-extended configuration.

The stylus pen 100 can also include a camera shutter trigger. This may be, for example, a Bluetooth® function or a cable that plugs into an audio jack of a camera or smartphone. The handle section of the stylus pen 100 can include a button for activating the camera shutter trigger.

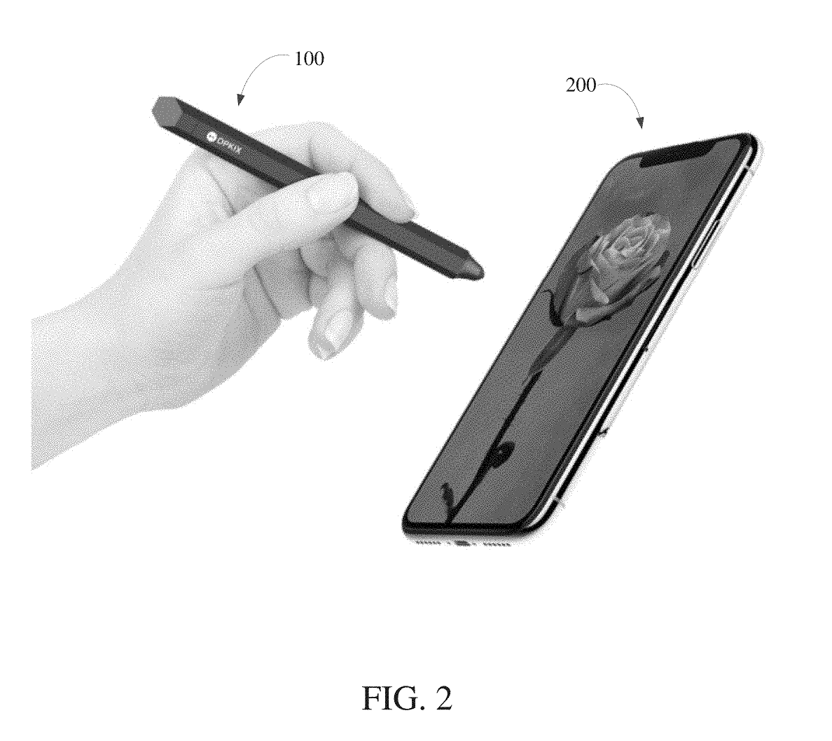

FIG. 2 illustrates the stylus pen 100 in a non-extended configuration while in use for providing input to a personal computing device 200. As illustrated, in some embodiments, the personal computing device can be a smartphone. Though in other embodiments, the personal computing device can be a notebook computer, a tablet computer, etc. In the embodiment shown in FIG. 1, the camera mount 140 is a magnetic mount and the camera 150 is shown as having been removed.

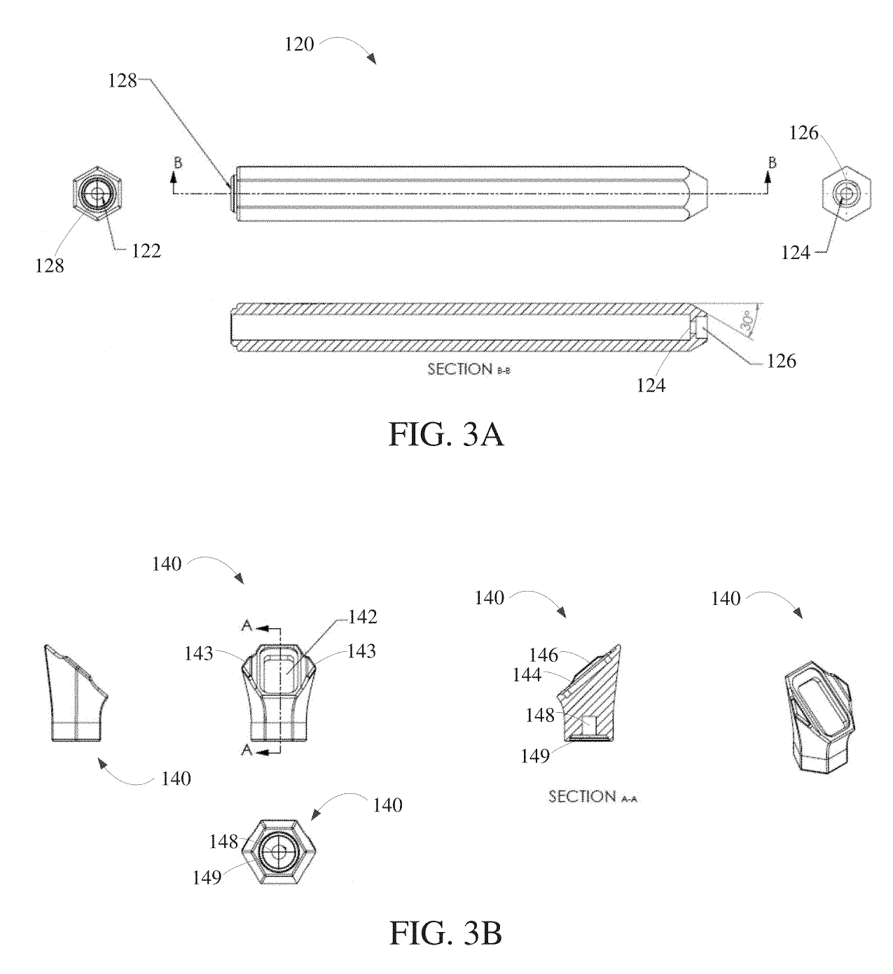

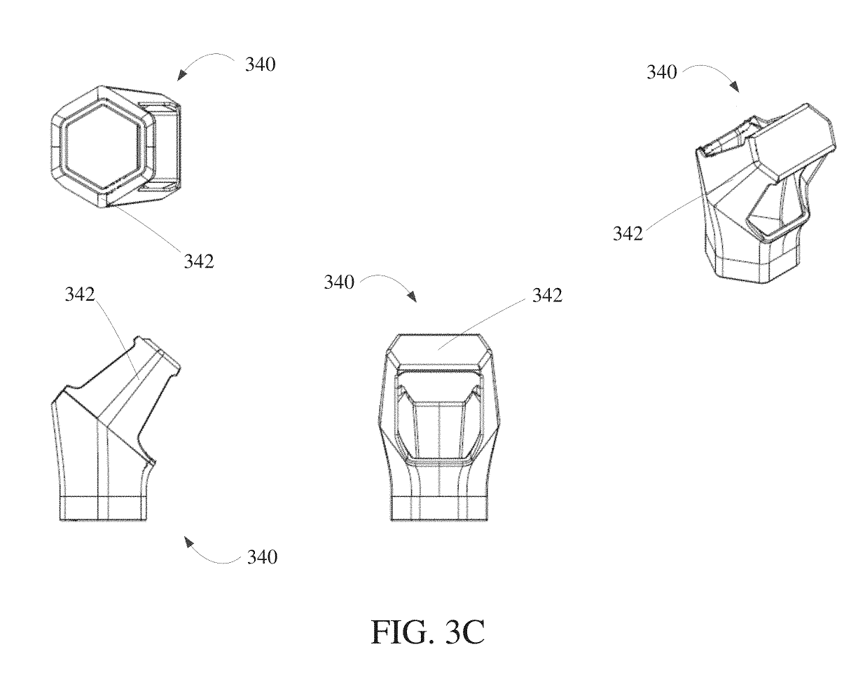

FIG. 3A illustrates an example embodiment of the handle section 120 of the stylus pen 100. The figure includes top, side, bottom, and cross-sectional views (left-to-right and top-to-bottom) of the handle section 120. As shown in the cross-sectional view (through the section B-B), the handle section 120 may be hollow in order to receive the telescoping shaft 130. Access holes 122, 124 can be provided at the top and bottom of the handle section 120 to facilitate insertion of, and/or access to, the telescoping shaft 130. In some embodiments, the telescoping shaft 130 may be pressed or otherwise fixed into the access hole 124 at the tip end of the handle section 120 to prevent the telescoping shaft from pulling out of the handle section when it is pulled into the extended position by the user. As shown, the tip end of the handle section may be tapered and may include a depression 126 to receive the stylus pen tip 110, which may be made of a resilient material such as soft rubber. A locating feature 122 can be provided at the top end of the handle section 120. The locating feature 122 can be, for example, a projection (as shown in FIG. 3A) or depression that mates with a complementary structure in the camera mount 140 when the telescoping shaft 130 is in the non-extended position. Although the locating feature 122 is illustrated as being circular in FIG. 3A, it may alternatively be non-circular so as to position the camera mount 140 at a particular rotational orientation when the locating feature 122 is engaged with the camera mount.

FIG. 3B illustrates an example embodiment of the camera mount 140 for the stylus pen 100. The figure includes side, front, cross-sectional, perspective, and bottom views (left-to-right and top-to-bottom) of the camera mount 140. The bottom portion of the camera mount 140 can include a depression 140 for receiving the telescoping shaft 130. The end of the telescoping shaft 130 can be pressed or otherwise fixed into the depression 140. The bottom portion of the camera mount 140 can also include a locating feature 149. In this case, the locating feature 149 is a depression that physically complements the locating feature 128 at the top of the handle section 120. In some embodiments, the complementary locating features 128, 149 may be designed to mate with tactile feedback, such as a click or snap. The top of the illustrated camera mount 140 includes a depression 142 for holding a magnet 144. The camera mount 140 can also include a ledge around the depression 142. This allows a cover plate 146 to be flushly positioned over the magnet 144. The top of the camera mount 140 can also include anti-rotation features 143. In this case the anti-rotation features 143 are projections positioned at opposing sides of the mounting surface. The anti-rotation features 143 help prevent the camera from rotating when it is magnetically coupled to the camera mount 140.

FIG. 3C illustrates another example embodiment of a camera mount 340 for the stylus pen 100. The figure includes top, perspective, side, and front views (left-to-right and top-to-bottom) of the camera mount 340. The bottom of the camera mount 340 can include a depression to receive the telescoping shaft 130, as shown in FIG. 3B. It can also include a locating feature, as also shown in FIG. 3B. However, rather than being a magnetic camera mount, the camera mount 340 shown in FIG. 3C includes a resilient loop 342 (e.g., made of soft rubber) which wraps around the camera 150 and holds it in position against the angled mating surface. The resilient loop 342 can be sized and shaped so as to correspond to the cross-sectional dimensions of the camera 150 so as to firmly attach the camera 150 to the camera mount 340.

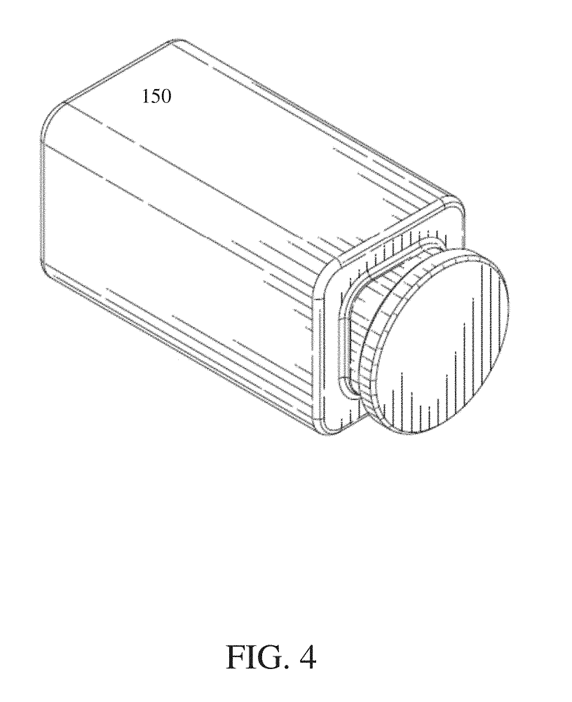

FIG. 4 illustrates an example embodiment of a camera 150 which can be attached to the integrated camera mount 140 of the stylus pen 100. In some embodiments, the camera 150 can be the Opkix® One camera, available from Opkix, Inc. Other Considerations

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A device comprising:
a shaft;
a stylus pen tip at a first end of the shaft, the stylus pen tip being configured to operate a touchscreen device;
a camera mount at a second end of the shaft, the camera mount being configured to securely attach a camera to the shaft.

2. The device of claim 1, wherein the shaft is a telescoping shaft.

3. The device of claim 2, wherein the telescoping shaft comprises a plurality of sections and one of the sections is a handle section.

4. The device of claim 3, wherein the handle section includes a camera shutter trigger button.

5. The device of claim 1, wherein the stylus pen tip comprises a resilient material.

6. The device of claim 1, wherein the stylus pen tip is conductive stylus pen tip.

7. The device of claim 1, wherein the camera mount is a screw mount.

8. The device of claim 1, wherein the camera mount is a magnetic mount.

9. The device of claim 1, wherein the camera mount is a mechanical jaw mount.

10. The device of claim 1, wherein the camera mount has an angled mounting surface.

11. The device of claim 10, wherein the angled mounting surface has an angle of 20-70° with respect to a longitudinal axis of the device.

12. The device of claim 1, wherein the camera mount has an adjustable camera mounting angle.

13. The device of claim 1, wherein the touchscreen device comprises a camera, and wherein the camera mount is designed to securely hold the touchscreen device.

14. The device of claim 13, wherein the touchscreen device comprises a smartphone.

15. The device of claim 1, wherein the device is Bluetooth® enabled.
